(19) United States
(12) Patent Application Publication
(10) Pub. No.: US 2011/0224344 A1
(43) Pub. Date: Sep. 15, 2011

(54) Liquid Die Bonding Agent

(76) Inventors: Toyohiko Fujisawa, Ichihara-shi (JP); Daesup Hyun, Midland, MI (US); Junji Nakanishi, Sodegaura-shi (JP)

(21) Appl. No.: 13/119,694

(22) PCT Filed: Sep. 16, 2009
(86) PCT No.: PCT/JP2009/066718

§ 371 Date: May 26, 2011

(30) Foreign Application Priority Data
Sep. 17, 2008 (JP) JP 2008-237373

(51) Int. Cl. C09J 183/07; C09J 11/06

(52) U.S. Cl. 524/317; 524/500

(57) ABSTRACT

A liquid die bonding agent comprising (A) an organopolysiloxane that has at least 2 alkenyl groups in one molecule, (B) an organopolysiloxane that has at least 2 silicon-bonded hydrogen atoms in one molecule, (C) a hydrosilylation reaction action catalyst, (D) a hydrosilylation reaction inhibitor, and (E) an organic solvent that can dissolve components (A), (B), and (D), that is liquid, and that has a boiling point of 180° C. to 400° C. Also, the preceding liquid die bonding agent that additionally comprises (F) an organosilicon compound-based adhesion promoter.

### TECHNICAL FIELD

The present invention relates to a silicone-based liquid die bonding agent for bonding a semiconductor chip to an attachment site for the semiconductor chip.

### BACKGROUND ART

Both non-silicone compositions and silicone-based curable compositions are known as liquid die bonding agents for bonding a semiconductor chip to an attachment site for the semiconductor chip.

With regard to the non-silicone compositions, a thermo- and electroconductive polyimide resin is disclosed in Patent Reference 1; this thermo- and electroconductive polyimide resin forms a thermo- and electroconductive polyimide resin layer on the wafer back side by spin coating. Polyimide-based die adhesives, epoxy-based die adhesives, polyimidesiloxane-based die adhesives, and polyetheramide-based die adhesives are given as examples in Patent Reference 2; these adhesives are coated—for example, by spin coating or with a dispenser—on the lead bonding region of the wafer. Patent Reference 3 teaches the mounting of a sealed device on an organic substrate (package) using an epoxy die bonding agent.

With regard to the silicone-based curable compositions, Patent Reference 4 discloses an addition reaction-curable silicone rubber composition in which the content of low-molecular-weight siloxane is no greater than 500 ppm. Patent Reference 5 discloses an adhesive comprising (A) an organopolysiloxane that has at least 2 silicon-bonded alkenyl groups in one molecule, (B) an organopolysiloxane that has at least 2 silicon-bonded hydrogen atoms in one molecule, (C) an organosilicon compound that contains silicon-bonded alkoxy groups, (D) an organic or inorganic spherical filler, and (E) platinum or a platinum-based compound in a catalytic quantity. Patent Reference 6 discloses an adhesive silicone rubber composition that comprises (1) an organopolysiloxane that contains at least 2 silicon-bonded alkenyl groups in one molecule, (2) an organohydrogenpolysiloxane that contains at least 2 silicon-bonded hydrogen atoms in one molecule, (3) an adhesion promoter, and (4) an addition-reaction catalyst, and that contains no more than 3 weight % cyclic and straight chain low-molecular-weight nonfunctional siloxane having 11 to 50 silicon atoms.

However, these patent references in no way describe a method that uses a silicone-based curable composition on the wafer surface.

When, proceeding according to Patent Reference 1 or Patent Reference 2, a liquid die bonding agent that is a silicone-based curable composition is applied by spin coating on the surface of a wafer that is a precursor of a semiconductor chip, i.e., die, whiskers and fibrillar material are formed at the wafer edge and uniform coating cannot be performed as a result.
[Patent Reference 1] JP 08-236554 A
[Patent Reference 2] JP 10-144703 A (JP 2,925,074 B)
[Patent Reference 3] JP 2005-032872 A (JP 3,897,115 B)
[Patent Reference 4] JP 03-157474 A (JP 2,882,823 B)
[Patent Reference 5] JP 07-292343 A
[Patent Reference 6] JP 2002-060719 A

### DISCLOSURE OF THE INVENTION

### Problem to be Solved by the Invention

The inventors therefore carried out intensive investigations with regard to the spin coating application of a die bonding agent that is a silicone-based curable composition on the surface of a wafer that is a precursor of a semiconductor chip, i.e., die, in order to create a die bonding agent that is a silicone-based curable composition that can be uniformly coated over the entire wafer surface without forming whiskers or fibrillar material at the wafer edge. It was discovered as a result of these investigations that the aforementioned problem is eliminated by formulation as a solution in a special organic solvent.

The object of the present invention is to provide a liquid die bonding agent that is a silicone-based curable composition that can be uniformly coated over the entire wafer surface without forming whiskers or fibrillar material at the wafer edge—even in the case of the spin coating application of a die bonding agent that is a silicone-based curable composition on the surface of a wafer that is a precursor of a semiconductor chip, i.e., die.

### Means Solving the Problem

The present invention relates to
“[1] A liquid die bonding agent that comprises
   (A) 100 parts by mass of an organopolysiloxane that has at least 2 alkenyl groups in one molecule,
   (B) an organopolysiloxane that has at least 2 silicon-bonded hydrogen atoms in one molecule, in a quantity that provides 0.5 to 10 moles of silicon-bonded hydrogen atoms in this component per 1 mole of alkenyl group in component (A),
   (C) a hydrosilylation reaction catalyst, in a quantity sufficient to cure components (A) and (B),
   (D) a hydrosilylation reaction inhibitor, in a quantity sufficient to render components (A) and (B) not curable at ambient temperature but curable with the application of heat, and
   (E) an organic solvent that can dissolve components (A), (B), and (D), that is liquid at ambient temperature, and that has a boiling point of 180° C. to 400° C., in a quantity sufficient to dissolve components (A), (B), and (D).
[1-1] The liquid die bonding agent according to [1], characterized in that the alkenyl-containing organopolysiloxane is a methylvinylpolysiloxane or methylphenylvinylpolysiloxane; the organopolysiloxane containing silicon-bonded hydrogen atoms is a methylhydrogenpolysiloxane or methylphenylhydrogenpolysiloxane; and the hydrosilylation reaction catalyst is a platinum-based catalyst.
[2] The liquid die bonding agent according to [1] or [1-1], characterized in that the organic solvent is a hydrocarbon solvent or a polyalkylene glycol alkyl ether ester solvent.
[3] The liquid die bonding agent according to [1], characterized in that component (A) is
   (a-1) an organopolysiloxane resin that has at least 2 alkenyl groups in one molecule,
   (a-2) a straight-chain diorganopolysiloxane that has at least 2 alkenyl groups in one molecule, or
   a mixture of components (a-1) and (a-2) wherein the mass ratio between component (a-1) and component (a-2) is 50:50 to 99; 1.
[3-1] The liquid die bonding agent according to [3], characterized in that the alkenyl-containing siloxane resin is a methylvinylpolysiloxane resin or a methylphenylvinylpolysiloxane resin and the alkenyl-containing straight chain diorganopolysiloxane is a straight chain dimethylpolysiloxane or a straight chain methylphenylpolysiloxane having vinyl groups at both terminals.
[3-2] The liquid die bonding agent according to [3] or [3-1], characterized in that the organic solvent is a hydrocarbon solvent or a polyalkylene glycol alkyl ether ester solvent.
[4] The liquid die bonding agent according to [1], [1-1], or [2], that further comprises (F) an organosilicon compound-based adhesion promoter, at 0.1 to 10 parts by mass per 100 parts by mass of component (A).
[4-1] The liquid die bonding agent according to [3], [3-1] or [3-2], that further comprises (F) an organosilicon compound-based adhesion promoter, at 0.1 to 10 parts by mass per 100 parts by mass of component (A).”

### Effects of the Invention

The liquid die bonding agent of the present invention can be uniformly coated over the entire wafer surface without forming whiskers or fibrillar material at the wafer edge—even in the case of the spin coating application of the liquid die bonding agent on the surface of a wafer that is a precursor of a semiconductor chip, i.e., die. This enables a secure and reliable feed to the dicing step, where the liquid die bonding agent-coated wafer is cut into chip form to yield semiconductor chips.

### BRIEF DESCRIPTION OF THE DRAWINGS

FIG. 1 is a photograph of uncured die bonding agent in a Comparative Example, wherein the uncured die bonding agent has formed whiskers and fibrillar material at the edge of a circular silicon wafer.

FIG. 2 is a photograph of uncured die bonding agent in an Example, wherein the uncured die bonding agent has not formed whiskers or fibrillar material at the edge of a circular silicon wafer.

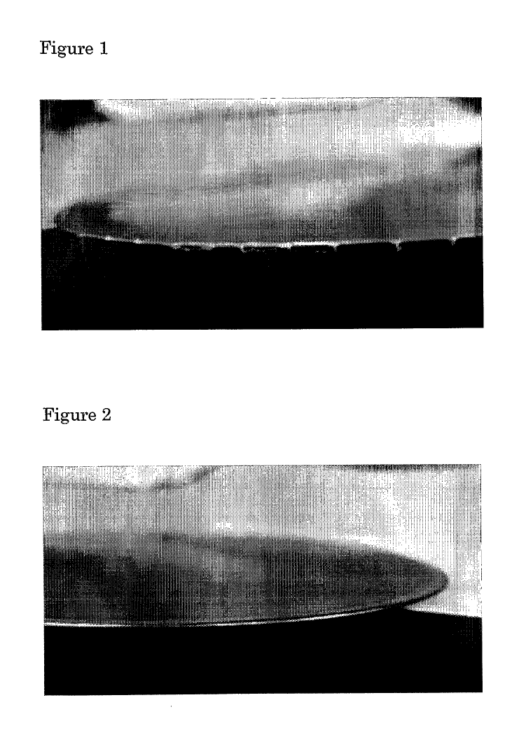

### MODES FOR CARRYING OUT THE INVENTION

The liquid die bonding agent of the present invention comprises
(A) 100 parts by mass of an organopolysiloxane that has at least 2 alkenyl groups in one molecule,
(B) an organopolysiloxane that has at least 2 silicon-bonded hydrogen atoms in one molecule, in a quantity that provides 0.5 to 10 moles of silicon-bonded hydrogen atoms in this component per 1 mole of alkenyl group in component (A),
(C) a hydrosilylation reaction catalyst in a quantity sufficient to cure components (A) and (B),
(D) a hydrosilylation reaction inhibitor in a quantity sufficient to render components (A) and (B) not curable at ambient temperature but curable with the application of heat, and
(E) an organic solvent that can dissolve components (A), (B), and (D), that is liquid at ambient temperature, and that has a boiling point of 180° C. to 400° C., in a quantity sufficient to dissolve components (A), (B), and (D).

Component (A), an organopolysiloxane that has at least 2 alkenyl groups in one molecule, is the base component of the liquid die bonding agent of the present invention. Under the catalytic action of component (C), curing occurs by a hydrosilylation reaction-induced crosslinking between the alkenyl groups in component (A) and the silicon-bonded hydrogen atoms in component (B).

The following are representative examples of component (A): (a-1) an organopolysiloxane resin that has at least 2 alkenyl groups in one molecule, (a-2) a straight-chain diorganopolysiloxane that has at least 2 alkenyl groups in one molecule, and mixtures of components (a-1) and (a-2) wherein the mass ratio between component (a-1) and component (a-2) is 50:50 to 99:1.

Component (a-1) has at least 2 and preferably at least 3 alkenyl groups in one molecule. It has, for example, a branched, network, or cage molecular structure. Component (a-1) can be represented by the following average siloxane unit formula:

RₐSiO_{(4-a)/2} (1)

wherein R is a C₁ to C₁₀ monovalent hydrocarbyl group and a is a number with an average value in the range of 0.5<a<1.7.

R is C₁ to C₁₀ monovalent hydrocarbyl and is bonded to the silicon in the organopolysiloxane. The C₁ to C₁₀ monovalent hydrocarbyl group can be exemplified by alkyl such as methyl, ethyl, n-propyl, isopropyl, n-butyl, isobutyl, sec-butyl, tert-butyl, hexyl, octyl, and so forth; haloalkyl such as 3-chloropropyl, 3,3,3-trifluoropropyl, and so forth; aryl such as phenyl, tolyl, xylyl, and so forth; aralkyl such as benzyl, phenylethyl, and so forth; and C₂ to C₁₀ unsaturated aliphatic hydrocarbyl and particularly alkenyl, such as vinyl, 1-propenyl, allyl, isopropenyl, 1-butenyl, 2-butenyl, 1-hexenyl, and so forth. Preferred among the preceding are methyl and vinyl or methyl and phenyl and vinyl.

Component (a-1) can be exemplified by the following (R in the formulas is as described above):
an organopolysiloxane resin comprising siloxane units represented by the formula R₃SiO_{1/2} and siloxane units represented by the formula SiO_{4/2};
an organopolysiloxane resin comprising siloxane units represented by the formula R₃SiO_{1/2}, siloxane units represented by the formula R₂SiO_{2/2}, and siloxane units represented by the formula SiO_{4/2};
an organopolysiloxane resin comprising siloxane units represented by the formula RSiO_{3/2};
an organopolysiloxane resin comprising siloxane units represented by the formula RSiO_{3/2} and siloxane units represented by the formula R₂SiO_{2/2};
an organopolysiloxane resin comprising siloxane units represented by the formula RSiO_{3/2} and siloxane units represented by the formula R₃SiO_{1/2}; and
an organopolysiloxane resin comprising siloxane units represented by the formula RSiO_{3/2}, siloxane units represented by the formula R₂SiO_{2/2}, and siloxane units represented by the formula R₃SiO_{1/2}.

The organopolysiloxane resin comprising siloxane units represented by the formula R₃SiO_{1/2} and siloxane units represented by the formula SiO_{4/2} is preferably an organopolysiloxane resin comprising the siloxane unit represented by the formula R¹₃SiO_{1/2}, siloxane units represented by the formula R¹₂R²SiO_{1/2}, and siloxane units represented by the formula SiO_{4/2}. R¹ in these formulas is a C₁ to C₁₀ monovalent hydrocarbyl group that lacks an unsaturated aliphatic bond and can be exemplified by alkyl such as methyl, ethyl, n-propyl, isopropyl, n-butyl, isobutyl, sec-butyl, tert-butyl, hexyl, octyl, and so forth; haloalkyl such as 3-chloropropyl, 3,3,3-trifluoropropyl, and so forth; aryl such as phenyl, tolyl, xylyl, and so forth; and aralkyl such as benzyl, phenylethyl, and so forth. R² is a C₂ to C₁₀ alkenyl and can be exemplified by vinyl, allyl, butenyl, pentenyl, hexenyl, and heptenyl.

The organopolysiloxane resin comprising the siloxane units represented by the formula RSiO_{3/2} and siloxane units represented by the formula R₂SiO_{2/2} is preferably an organopolysiloxane resin comprising siloxane units represented by the formula R¹SiO_{3/2}, siloxane units represented by the formula R¹₂SiO_{2/2}, and siloxane units represented by the formula R¹R²SiO_{2/2} wherein R¹ and R² in the formulas are the same as previously described.

The following are preferred specific examples of the organopolysiloxane resin comprising siloxane units represented by the formula RSiO_{3/2} and siloxane units represented by the formula SiO_{4/2}: a methylvinylpolysiloxane resin comprising siloxane units represented by (CH₃)₃SiO_{1/2}, siloxane units represented by the formula (CH₃)₂(CH₂═CH)SiO_{1/2}, and siloxane units represented by the formula SiO_{4/2}, and a methylphenylvinylpolysiloxane resin comprising siloxane units represented by (C₆H₅)(CH₃)₂SiO_{1/2}, siloxane units represented by the formula (CH₃)₂(CH₂═CH)SiO_{1/2}, and siloxane units represented by the formula SiO_{4/2}.

A methylphenylvinylpolysiloxane resin comprising siloxane units represented by (C₆H₅)SiO_{3/2}, siloxane units represented by the formula (CH₃)₂SiO_{2/2}, and siloxane units represented by (CH₃)(CH₂═CH)SiO_{2/2} is a preferred specific example of the organopolysiloxane resin comprising siloxane units represented by the formula R¹SiO_{3/2}, siloxane units represented by the formula R¹₂SiO_{2/2}, and siloxane units represented by the formula R¹R²SiO_{2/2}.

Component (a-1) may contain small quantities of silanol groups and/or silicon-bonded alkoxy groups.

Component (a-1) may be a liquid, semisolid, or solid at room temperature. When it is a liquid, its viscosity at 25° C. is preferably in the range of 100 to 500,000 mPa·s and more preferably is in the range of 500 to 100,000 mPa·s.

Two or more of the preceding may be used in combination as component (a-1).

Component (a-2), a straight-chain diorganopolysiloxane that has at least 2 alkenyl groups in one molecule, cures by crosslinking brought about by the hydrosilylation reaction of the alkenyl groups in this component with the silicon-bonded hydrogen atoms in component (B) under the catalytic action of component (C).

The alkenyl group in this component can be exemplified by vinyl, allyl, butenyl, pentenyl, hexenyl, and heptenyl wherein vinyl is preferred. The bonding position for this alkenyl group is not particularly limited and the alkenyl group can be bonded only in molecular chain terminal positions, only in side chain positions on the molecular chain, or in both terminal positions and side chain positions on the molecular chain.

The non-alkenyl silicon-bonded organic groups in component (a-2) can be exemplified by alkyl such as methyl, ethyl, propyl, butyl, pentyl, hexyl, heptyl, and so forth; aryl such as phenyl, tolyl, xylyl, naphthyl, and so forth; aralkyl such as benzyl, phenethyl, and so forth; and haloalkyl groups such as 3-chloropropyl, 3,3,3-trifluoropropyl, and so forth; wherein only methyl or methyl plus phenyl is preferred.

The following are examples of this (a-2);
dimethylsiloxane.methylvinylsiloxane copolymer endblocked by trimethylsiloxy groups at both molecular chain terminals,
methylvinylpolysiloxane endblocked by trimethylsiloxy groups at both molecular chain terminals,
dimethylsiloxane.methylvinylsiloxane.methylphenylsiloxane copolymer endblocked by trimethylsiloxy groups at both molecular chain terminals,
dimethylpolysiloxane endblocked by dimethylvinylsiloxy groups at both molecular chain terminals,
methylvinylpolysiloxane endblocked by dimethylvinylsiloxy groups at both molecular chain terminals,
dimethylsiloxane.methylvinylsiloxane copolymer endblocked by dimethylvinylsiloxy groups at both molecular chain terminals, and
dimethylsiloxane.methylvinylsiloxane.methylphenylsiloxane copolymer endblocked by dimethylvinylsiloxy groups at both molecular chain terminals.

The viscosity of component (a-2) is not particularly limited, but its viscosity at 25° C. is preferably in the range of 10 to 1,000,000 mPa·s and more preferably is in the range of 100 to 100,000 mPa·s. The reasons for this are as follows: when the viscosity of component (a-2) at 25° C. is less than the lower limit on the range given above, the resulting die bonding agent will flow out after printing into areas surrounding the coated region, contaminating the wire bonding pad and creating the risk that a defective wire bond will occur; on the other hand, the handling characteristics of the resulting die bonding agent deteriorate when the viscosity exceeds the upper limit on the range given above. Two or more species may be used in combination as component (a-2).

A combination of component (a-1) and component (a-2) may be used as component (A). The mass ratio between component (a-1) and component (a-2) is in the range from 50:50 to 99:1 and preferably is in the range from 60:40 to 96:4. The reasons for this are as follows: the physical strength of the cured product from the resulting die bonding agent declines when the mass ratio for component (a-1) is less than the lower limit on the aforementioned range; when, on the other hand, the upper limit on the aforementioned range is exceeded, the elongation of the cured product from the resulting die bonding agent tends to become too small.

Component (B), an organopolysiloxane that has at least 2 silicon-bonded hydrogen atoms in one molecule, is a crosslinking agent for component (A). Under the catalytic action of component (C), the silicon-bonded hydrogen atoms in component (B) undergo a hydrosilylation reaction-induced crosslinking with the alkenyl groups in component (A). The bonding position of the silicon-bonded hydrogen atoms in component (B) is not particularly limited, and, for example, the silicon-bonded hydrogen atom can be bonded only in molecular chain terminal positions, only in side chain positions on the molecular chain, or in both terminal positions and side chain positions on the molecular chain.

The silicon-bonded organic groups in component (B) can be exemplified by alkyl such as methyl, ethyl, propyl, butyl, pentyl, hexyl, heptyl, and so forth; aryl such as phenyl, tolyl, xylyl, naphthyl, and so forth; aralkyl such as benzyl, phenethyl, and so forth; and haloalkyl such as 3-chloropropyl, 3,3,3-trifluoropropyl, and so forth. Methyl alone or methyl plus phenyl is preferred.

The molecular structure of this component (B) is not particularly limited, and component (B) may have, for example, a straight chain, partially branched straight chain, branched chain, cyclic, or network molecular structure, wherein the straight chain, partially branched straight chain, and branched chain are preferred.

Component (B) can be exemplified by the following:
methylhydrogenpolysiloxane endblocked at both molecular chain terminals by trimethylsiloxy groups;
dimethylsiloxane.methylhydrogensiloxane copolymer endblocked at both molecular chain terminals by trimethylsiloxy groups;
dimethylsiloxane.methylhydrogensiloxane.methylphenylsiloxane copolymer endblocked at both molecular chain terminals by trimethylsiloxy groups;
dimethylpolysiloxane endblocked at both molecular chain terminals by dimethylhydrogensiloxy groups;
dimethylsiloxane.methylphenylsiloxane copolymer endblocked at both molecular chain terminals by dimethylhydrogensiloxy groups;
methylphenylpolysiloxane endblocked at both molecular chain terminals by dimethylhydrogensiloxy groups;
cyclic methylhydrogenpolysiloxane;
   an organohydrogenpolysiloxane comprising siloxane units represented by the formula R¹₃SiO_{1/2}, siloxane units represented by the formula R¹₂HSiO_{1/2}, and siloxane units represented by the formula SiO_{4/2};
an organohydrogenpolysiloxane comprising siloxane units represented by R¹₂HSiO_{1/2} and siloxane units represented by SiO_{4/2};
an organohydrogenpolysiloxane comprising siloxane units represented by the formula R¹HSiO_{2/2} and siloxane units represented by the formula R¹SiO_{3/2} or siloxane units represented by the formula HSiO_{3/2}; and
a mixture of two or more of these organohydrogenpolysiloxanes.

R¹ in the preceding formulas is a monovalent hydrocarbyl group that lacks an aliphatically unsaturated bond and can be specifically exemplified by alkyl such as methyl, ethyl, propyl, butyl, pentyl, hexyl, heptyl, and so forth; aryl such as phenyl, tolyl, xylyl, naphthyl, and so forth; aralkyl such as benzyl, phenethyl, and so forth; and haloalkyl such as 3-chloropropyl, 3,3,3-trifluoropropyl, and so forth.

The viscosity of component (B) is not particularly limited, but the viscosity at 25° C. is preferably in the range from 1 to 200,000 mPa·s and more preferably is in the range from 5 to 50,000 mPa·s. The reasons for this are as follows: the mechanical strength of the cured product from the resulting die bonding agent declines when component (B) has a viscosity at 25° C. below the lower limit for the aforementioned range; on the other hand, when component (B) has a viscosity at 25° C. in excess of the upper limit on the range given above, its synthesis becomes difficult and the handling characteristics of the resulting die bonding agent deteriorate.

Component (B) is incorporated in an amount that provides 0.5 to 10 moles, preferably 0.8 to 5 moles, and particularly preferably 0.9 to 3 moles of silicon-bonded hydrogen atoms in component (B) per 1 mole of alkenyl group in component (A). The reasons for this are as follows: the resulting liquid die bonding agent exhibits a tendency to inadequately cure when the silicon-bonded hydrogen atoms in component (B) per 1 mole of alkenyl group in component (A) is less than the lower limit on the aforementioned range; on the other hand, the physical properties of the cured product from the resulting die bonding agent exhibit a timewise deterioration when the upper limit on the aforementioned range is exceeded.

Component (C), a catalyst for the hydrosilylation reaction, acts to promote the hydrosilylation reaction between the alkenyl groups in component (A) and the silicon-bonded hydrogen atoms in component (B), thus bringing about curing by bringing about crosslinking between components (A) and (B).

This component (C) can be exemplified by noble metal catalysts from Group 8 of the Periodic Table, such as platinum-based catalysts, rhodium-based catalysts, and palladium-based catalysts, wherein platinum-based catalysts are preferred from the standpoints of catalytic performance and ease of acquisition. These platinum-based catalysts can be exemplified by the following: finely divided platinum, platinum black, platinum supported on finely divided silica, platinum supported on active carbon, chloroplatinic acid, platinum tetrachloride, alcohol-modified chloroplatinic acid solutions, platinum/diolefin complexes, chloroplatinic acid/diolefin complexes, platinum/β-diketone complexes, chloroplatinic acid/β-diketone complexes, complexes between platinum and an alkenylsiloxane oligomer (e.g., divinyltetramethyldisiloxane, cyclic methylvinylsiloxane oligomer, and so forth), complexes between chloroplatinic acid and an alkenylsiloxane oligomer (e.g., divinyltetramethyldisiloxane, cyclic methylvinylsiloxane oligomer, and so forth), and powder with a particle size below 10 μm of a thermoplastic resin (e.g., polystyrene resin, nylon resin, polycarbonate resin, silicone resin, and so forth) comprising platinum or a platinum compound as described in the preceding.

Component (C) is incorporated in an amount sufficient to bring about curing through hydrosilylation reaction-induced crosslinking between component (A) and component (B), that is, in what is known as a catalytic quantity. When component (C) is a noble metal catalyst from Group 8 of the Periodic Table, and particularly when it is a platinum-based catalyst, it is incorporated in specific terms in an amount that gives preferably 0.1 to 500 ppm by mass and more preferably 1 to 50 ppm by mass for the amount of metal in component (C) in the die bonding agent of the present invention. The reasons for this are as follows: the cure rate of the resulting die bonding agent undergoes a substantial decline when the amount of component (C) incorporation is less than the lower limit on the aforementioned range; on the other hand, a substantial increase in the cure rate is not seen even when the upper limit on the aforementioned range is exceeded, which is thus uneconomical.

Because curing starts to occur even at ambient temperature when components (A), (B), and (C) are mixed together, the die bonding agent of the present invention preferably contains a hydrosilylation reaction inhibitor. Hydrosilylation reaction inhibitors are known and can be exemplified by alkyne alcohols such as 2-methyl-3-butyn-2-ol, 3,5-dimethyl-1-hexyn-3-ol, phenylbutynol, and so forth; ene-yne compounds such as 3-methyl-3-penten-1-yne, 3,5-dimethyl-3-hexen-1-yne, and so forth; unsaturated dicarboxylic acid esters such as dimethyl maleate, diethyl fumarate, bis(2-methoxy-1-methylethyl) maleate, and so forth; alkyneoxysilanes such as methyl{tris(1,1-dimethyl-2-propynyloxy)}silane, dimethyl{bis(1,1-dimethyl-2-propynyloxy)}silane and so forth; methylvinylsiloxane oligomers such as 1,3,5,7-tetramethyl-1,3,5,7-tetravinylcyclotetrasiloxane, 1,3,5,7-tetramethyl-1,3,5,7-tetrahexenylcyclotetrasiloxane, and so forth; and benzotriazole.

This hydrosilylation reaction inhibitor is incorporated in a quantity sufficient to render components (A) and (B) not curable at ambient temperature but curable with the application of heat and in specific terms is preferably incorporated at from 10 to 50,000 ppm by mass with reference to the total quantity of components (A), (B), and (C).

Component (E) is an organic solvent that can dissolve components (A), (B), and (D), that is liquid at ambient temperature, and that has a boiling point of 180° C. to 400° C. Component (E) functions to enable uniform application over the entire wafer surface even in the case of the spin coating application of the liquid die bonding agent on the surface of a wafer that is a precursor of a semiconductor chip, i.e., die. Here, ambient temperature is the average annual temperature and generally denotes 15° C.

Typical examples of component (E) are hydrocarbon solvents, diphenyl ether solvents, polyalkylene glycol dialkyl ether solvents, and polyalkylene glycol alkyl ether ester solvents, that are liquid at ambient temperature and that have a boiling point at ambient pressure of 180° C. to 400° C. Specific examples are alkanes that are liquid at ambient temperature and that have a boiling point of 180° C. to 290° C. such as undecane, dodecane, tetradecane, and pentadecane; solvent naphtha having a boiling point of 190° C. to 210° C.; tetrahydronaphthalene having a boiling point of 206 to 208° C.; decahydronaphthalene having a boiling point of 187° C.; alkylbenzenes that are liquid at ambient temperature and that have a boiling point of 270 to 320° C. such as dodecylbenzene; diphenyl ether, dibenzyl ether, ditolyl ether, and diethylene glycol alkyl ethers, that in each case are liquid at ambient temperature and have a boiling point of 180° C. to 290° C. which can be exemplified by diethylene glycol dimethyl ether and diethylene glycol dibutyl ether; and diethylene glycol alkyl ether esters that are liquid at ambient temperature and that have a boiling point of 180° C. to 290° C. which can be exemplified by diethylene glycol monoethyl ether acetate having a boiling point of 217.7° C. and diethylene glycol mono-n-butyl acetate having a boiling point of 246.7° C.

Component (E) is incorporated in a quantity sufficient to dissolve components (A), (B), and (D). Since the solubility varies with the nature of component (E) and the nature of components (A), (B), and (D), a specific rule for the quantity of component (E) incorporation is problematic; however, 1 to 50 parts by mass per 100 parts by mass of component (A) can be used as a guideline.

Component (F), an organosilicon compound-based adhesion promoter, functions to improve the adhesiveness to the wafer and/or semiconductor die or semiconductor substrate with which the die bonding agent of the present invention is in contact during its cure. Organosilanes having a trialkoxysilyl group or dialkoxysilyl group and organosiloxane oligomers having a trialkoxysilyl group or dialkoxysilyl group are preferred. Also preferred are organosilanes and organosiloxane oligomers that, in addition to a trialkoxysilyl group or dialkoxysilyl group, contain any selection or a plurality of selections from lower alkenyl, hydrosilyl, glycidoxyalkyl, epoxycyclohexylalkyl, and methacryloxyalkyl.

Component (F) can be exemplified by alkoxysilane compounds such as tetramethoxysilane, tetraethoxysilane, dim ethyldimethoxysilane, methylphenyldimethoxysilane, methylphenyldiethoxysilane, phenyltrimethoxysilane, methyltrimethoxysilane, methyltriethoxysilane, vinyltrimethoxysilane, allyltrimethoxysilane, allyltriethoxysilane, 3-glycidoxypropyltrimethoxysilane, 3-methacryloxypropyltrimethoxysilane, and so forth, and by organosiloxane oligomers with the following average structural formulas.

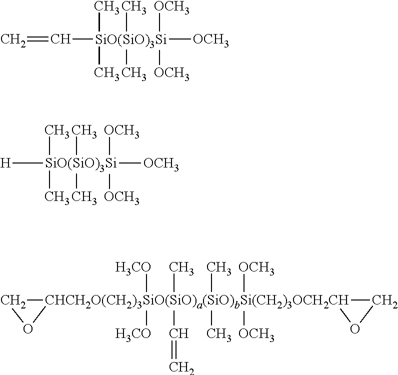

In the formula, a is a number greater than or equal to 1 and less than or equal to 20 and b is a number greater than or equal to 1 and less than or equal to 20.

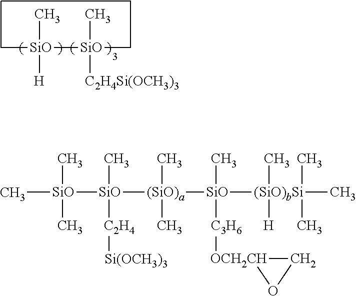

In the formula, a is a number greater than or equal to 1 and less than or equal to 20 and b is a number greater than or equal to 1 and less than or equal to 20.

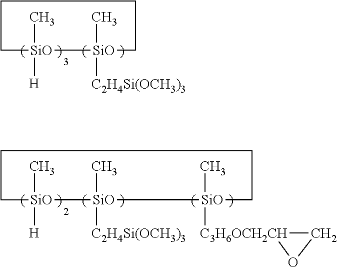

Among the previously described examples of component (F), the following are preferred because they provide a particularly good adhesion to the wafer with which the die bonding agent of the present invention is in contact during its cure: organosilanes and organosiloxane oligomers that have a trialkoxysilyl group exemplified by trimethoxysilyl and triethoxysilyl or dialkoxysilyl group exemplified by dimethoxysilyl, and diethoxysilyl and that also have any selection or a plurality of selections from lower alkenyl exemplified by vinyl, and allyl, hydrosilyl, glycidoxyalkyl exemplified by glycidoxypropyl, epoxycyclohexylalkyl exemplified by 3,4-epoxycyclohexylethyl, and methacryloxyalkyl exemplified by methacryloxypropyl.

Component (F) is incorporated at from 0.1 to 10 parts by mass per 100 parts by mass of component (A) and is preferably incorporated at from 0.5 to 3.0 parts by mass per 100 parts by mass of component (A). The reasons for this are as follows: when the amount of component (F) incorporation is less than the lower limit on the aforementioned range, the cured product from the resulting die bonding agent does not demonstrate a satisfactory adhesiveness; when, on the other hand, the upper limit on the aforementioned range is exceeded, the resulting die bonding agent will have a reduced storage stability and/or physical characteristics of the cured product will be affected.

The liquid die bonding agent of the present invention can be prepared by mixing components (A) to (E) or components (A) to (F) to uniformity. In order to improve the storage stability, two mixtures may be prepared wherein components (B) and (C) are not present together, and the liquid die bonding agent of the present invention may then be prepared by mixing prior to spin coating.

The liquid die bonding agent of the present invention has a viscosity at 25° C. preferably of 100 to 50,000 mPa·s and more preferably of 500 to 20,000 mPa·s. This is because the spin coatability declines when this viscosity is outside the aforementioned range. At below the lower limit on the aforementioned range, there is a risk of contamination of wire bond pads due to outflow after application; on the other hand, the generation of voids in the coating is prone to occur when the upper limit on the aforementioned range is exceeded.

Insofar as the object of the present invention is not impaired, the liquid die bonding agent of the present invention may also contain the additives typically used in hydrosilylation reaction-curable organopolysiloxane compositions, e.g., pigments, fillers, heat stabilizers, flame retardants, and so forth.

The liquid die bonding agent of the present invention can be cured by spin coating on a semiconductor wafer, evaporating component (E), and heating to a temperature sufficient to effect curing by crosslinking between components (A) and (B).

### EXAMPLES

The liquid die bonding agent of the present invention will be explained in detail through examples. The viscosity in the examples and comparative examples is the value measured at 25° C. The following methods were used in the examples and comparative examples to evaluate the properties of the die bonding agents.

[Viscosity of Liquid Die Bonding Agent]

The viscosity of the liquid die bonding agent was measured at a shear rate of 10 (1/s) using a rheometer (AR550 from TA Instruments Japan).

[Presence/Absence of Whiskers and Fibrillar Material at the Wafer Edge]

The liquid die bonding agent was dripped onto the center of a circular silicon wafer with a 4-inch diameter. Coating was then performed using a spin coater (2500 rpm) to provide a liquid die bonding agent thickness of 40 μm. Whether or not whiskers and/or fibrillar material formed at the wafer edge was then visually evaluated.

[Tensile Strength and Elongation of the Cured Product from the Liquid Die Bonding Agent]

The liquid die bonding agent was poured into a molding frame and, while the upper surface was left open, the solvent was evaporated by heating for 1 hour at 100° C. in a convection oven. The die bonding agent was then cured by heating for 1 hour at 175° C. and cured product with the #3 dumbbell shape specified in JIS K 6251-1993 (“Tensile Testing Methods for Vulcanized Rubber”) was fabricated. The thickness, however, was 0.6 mm±0.2 mm. The tensile strength and elongation of this cured product were measured by the methods specified in JIS K 6251-1993.

[Adhesiveness of the Liquid Die Bonding Agent]

The liquid die bonding agent was coated on an aluminum sheet and the solvent was evaporated by heating for 1 hour at 100° C. in a convection oven. Then, using a separate aluminum sheet, this was sandwiched so as to provide a thickness of 1 mm and the die bonding agent was cured by heating for 60 minutes in a 175° C. convection oven to produce an adhesion test specimen. The tensile shear adhesive strength of this adhesive test specimen was measured according to the method specified in JIS K 6850:1999 “Adhesives—Determination of tensile lap-shear strength of rigid-to-rigid bonded assemblies”.

### Example 1

The following were introduced into a mixer and mixed: 75 parts by mass of a methylvinylpolysiloxane resin (vinyl content=2.01% by mass) comprising siloxane units represented by the formula (CH₃)₃SiO_{1/2}, siloxane units represented by the formula (CH₃)₂(CH₂═CH)SiO_{1/2}, and siloxane units represented by the formula SiO_{4/2}, and 25 parts by mass of a dimethylpolysiloxane (viscosity=2,000 mPa·s, vinyl content=0.23% by mass) endblocked by dimethylvinylsiloxy groups at both molecular chain terminals. 13 parts by mass of dodecane (boiling point=216° C.) was introduced and mixing was carried out to produce a uniform solution. The following were added to this solution: 5.7 parts by mass of a methylhydrogenpolysiloxane (viscosity=20 mPa·s, silicon-bonded hydrogen atom content=1.5% by mass) endblocked by trimethylsiloxy groups at both molecular chain terminals (this quantity provided 1.5 moles of silicon-bonded hydrogen atoms in this methylhydrogenpolysiloxane per 1.0 mole of vinyl group in the aforementioned organopolysiloxane mixture),

1.0 part by mass of an organosilicon compound given by the following average structural formula,

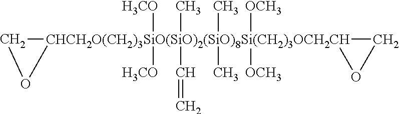

and 0.30 part by mass of 1-ethynyl-1-cyclohexanol, i.e., ETCH. After mixing for 10 minutes at room temperature, 0.23 part by mass of platinum/1,3-divinyltetramethyldisiloxane complex (this quantity provided 2.5 ppm by mass of platinum metal in the die bonding agent under consideration) was added and mixing was performed for 30 minutes at room temperature to produce a liquid die bonding agent. The characteristics of this die bonding agent were evaluated as described above, and the results are reported in Table 1.

### Example 2

A liquid die bonding agent was prepared employing the same conditions as in Example 1, but in this case using 13 parts by mass of MICSOL 2100 (MICSOL 2100 is a trade name for a paraffinic solvent from Michang Oil Ind. Co., Ltd., boiling point=194 to 249° C.) in place of the 13 parts by mass of dodecane used in Example 1. The characteristics of this die bonding agent were evaluated as described above, and the results are reported in Tables 1 and 2.

### Example 3

The following were introduced into a mixer and mixed: 70 parts by mass of a methylphenylvinylpolysiloxane resin given by the average siloxane unit formula: (C₆H₅SiO_{3/2})_{0.75}[(CH₃)₂SiO_{2/2}]_{0.15}[(CH₂═CH)CH₃SiO_{2/2}]_{0.10} (vinyl content=2.3% by mass, mass-average molecular weight=7,000, softening point=150° C.) and 30 parts by mass of a methylphenylpolysiloxane (viscosity=60,000 mPa·s, vinyl content=0.49% by mass) endblocked by dimethylvinylsiloxy groups at both molecular chain terminals and given by the following average structural formula.

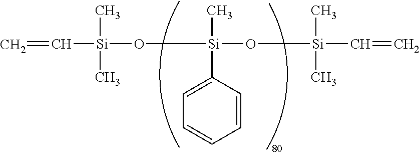

14 parts by mass of Tetralin (Tetralin is a registered trademark for tetrahydronaphthalene of Cognis IP Management Gesellschaft mit beschränkter Haftung) was then introduced into this mixture and mixing was carried out to produce a uniform solution.

The following were added to this solution: 15 parts by mass of a methylphenylhydrogenpolysiloxane with the average siloxane unit formula: (C₆H₅SiO_{3/2})_{0.4}[(CH₃)₂HSiO_{1/2}]_{0.60} that contained 6 silicon-bonded hydrogen atoms in one molecule (silicon-bonded hydrogen atom content=0.66% by mass, this quantity provided 1.5 moles of silicon-bonded hydrogen atoms in this methylphenylhydrogenpolysiloxane per 1.0 mole of vinyl group in the aforementioned organopolysiloxane mixture),

1.0 part by mass of N-phenyl-3-aminopropyltrimethoxysilane, and 3.0 parts by mass of methyl{tris(1,1-dimethyl-2-propynyloxy)}silane. After mixing for 10 minutes at room temperature, 0.45 part by mass of platinum/1,3-divinyltetramethyldisiloxane complex (this quantity provided 5 ppm by mass of platinum metal in the die bonding agent under consideration) was added and mixing was performed for 30 minutes at room temperature to produce a liquid die bonding agent. The characteristics of this liquid die bonding agent were evaluated as described above, and the results are reported in Table 1.

### Example 4

A liquid die bonding agent was prepared employing the same conditions as in Example 3, but in this case using 14 parts by mass of diethylene glycol monoethyl ether acetate (boiling point=217.4° C.) in place of the 14 parts by mass of Tetralin that was used in Example 3. The characteristics of this liquid die bonding agent were evaluated as described above, and the results are reported in Table 1.

### Example 5

The following were introduced into a mixer and mixed: 93 parts by mass of a methylphenylvinylpolysiloxane resin given by the average siloxane unit formula: (C₆H₅SiO_{3/2})_{0.75}[(CH₃)₂SiO_{2/2}]_{0.20}[(CH₂═CH)CH₃SiO_{2/2}]_{0.05} (vinyl content=1.2% by mass, mass-average molecular weight=7,000, softening point=150° C.) and 7.0 parts by mass of a dimethylphenylpolysiloxane (viscosity=2,000 mPa·s, vinyl content=1.7% by mass) endblocked by dimethylvinylsiloxy groups at both molecular chain terminals and given by the following average structural formula.

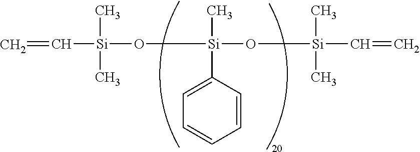

17 parts by mass of Swasol 1800 (Swasol 1800 is a trade name for solvent naphtha from Maruzen Petrochemical Co., Ltd., boiling point: 195 to 250° C.) was then added and mixing was carried out to produce a uniform solution.

The following were added to this solution: 12 parts by mass of a methylphenylpolysiloxane with the average siloxane unit formula (C₆H₅SiO_{3/2})_{0.40}[(CH₃)₂HSiO_{1/2}]_{0.06} that contained 6 silicon-bonded hydrogen atoms in one molecule (silicon-bonded atom content=0.66% by mass, this quantity provided 1.7 moles of silicon-bonded hydrogen atoms in this methylphenylhydrogenpolysiloxane per 1.0 mole of vinyl group in the aforementioned organopolysiloxane mixture), 1.0 part by mass of N-phenyl-3-aminopropyltrimethoxysilane, and 4.7 parts by mass of methyl{tris(1,1-dimethyl-2-propynyloxy)}silane. After mixing for 10 minutes at room temperature, 0.45 part by mass of platinum/1,3-divinyltetramethyldisiloxane complex (this quantity provided 5 ppm by mass of platinum metal in the die bonding agent under consideration) was added and mixing was performed for 30 minutes at room temperature to produce a liquid die bonding agent. The characteristics of this liquid die bonding agent were evaluated as described above, and the results are reported in Table 1.

### Comparative Example 1

A liquid die bonding agent was prepared as in Example 1, but in this case without adding the dodecane that was added in Example 1. However, the die bonding agent was too viscous and the viscosity could not be measured; nor could spin coating be performed.

### Comparative Example 2

A liquid die bonding agent was prepared as in Example 1, but in this case using xylene (boiling point=144° C.) in place of the dodecane used in Example 1. The characteristics of this liquid die bonding agent were evaluated as described above, and the results are reported in Tables 1 and 2.

### Comparative Example 3

A liquid die bonding agent was prepared as in Example 1, but in this case using mesitylene (boiling point=165° C.) in place of the dodecane used in Example 1. The characteristics of this liquid die bonding agent were evaluated as described above, and the results are reported in Table 1.

### Comparative Example 4

A liquid die bonding agent was prepared as in Example 3, but in this case using toluene (boiling point=110.6° C.) in place of the Tetralin used in Example 3. The characteristics of this liquid die bonding agent were evaluated as described above, and the results are reported in Table 1.

TABLE 1

| | | | | | | Comparative | | |
|---|---|---|---|---|---|---|---|---|
| | Examples | | | | | Examples | | |
| | 1 | 2 | 3 | 4 | 5 | 2 | 3 | 4 |
| viscosity | 6000 | 8000 | 1000 | 1000 | 3000 | 5500 | 6000 | 1000 |
| (mPa · s) | | | | | | | | |
| formation of | 0/3 | 0/3 | 0/3 | 0/3 | 0/3 | 3/3 | 2/3 | 3/3 |
| whiskers or | | | | | | | | |
| fibrillar | | | | | | | | |
| material | | | | | | | | |

TABLE 2

| | | | Comparative |
|---|---|---|---|
| | | Example 2 | Example 2 |
| tensile strength | MPa | 6.6 | 7.0 |
| elongation | % | 93 | 125 |
| tensile shear adhesive | N/cm² | 198 | 139 |
| strength | | | |

### INDUSTRIAL APPLICABILITY

The liquid die bonding agent of the present invention is useful as an adhesive for bonding a semiconductor chip to an attachment site for the semiconductor chip and in particular is useful for spin coating application to the surface of a wafer that is a precursor of a semiconductor chip, i.e., die.

1. A liquid die bonding agent that comprises
(A) 100 parts by mass of an organopolysiloxane that has at least 2 alkenyl groups in one molecule,
(B) an organopolysiloxane that has at least 2 silicon-bonded hydrogen atoms in one molecule, in a quantity that provides 0.5 to 10 moles of silicon-bonded hydrogen atoms in this component per 1 mole of alkenyl group in component (A),
(C) a hydrosilylation reaction catalyst, in a quantity sufficient to cure components (A) and (B),
(D) a hydrosilylation reaction inhibitor, in a quantity sufficient to render components (A) and (B) not curable at ambient temperature but curable with the application of heat, and
(E) an organic solvent that can dissolve components (A), (B), and (D), that is liquid at ambient temperature, and that has a boiling point of 180° C. to 400° C., in a quantity sufficient to dissolve components (A), (B), and (D).

2. The liquid die bonding agent according to claim 1,
wherein the organic solvent is a hydrocarbon solvent or a polyalkylene glycol alkyl ether ester solvent.

3. The liquid die bonding agent according to claim 1,
wherein component (A) is
(a-1) an organopolysiloxane resin that has at least 2 alkenyl groups in one molecule,
(a-2) a straight-chain diorganopolysiloxane that has at least 2 alkenyl groups in one molecule, or
a mixture of components (a-1) and (a-2) wherein the mass ratio between component (a-1) and component (a-2) is 50:50 to 99:1.

4. The liquid die bonding agent according to claim 1, further comprising (F) an organosilicon compound-based adhesion promoter, at 0.1 to 10 parts by mass per 100 parts by mass of component (A).

5. The liquid die bonding agent according to claim 1, wherein
the alkenyl containing organopolysiloxane is a methylvinylpolysiloxane or methylphenylvinylsiloxane,
the organopolysiloxane containing silicon-bonded hydrogen atoms is a methylhydrogenpolysiloxane, and
the hydrosilylation reaction catalyst is a platinum-based catalyst.

6. The liquid die bonding agent according to claim 3, wherein
the alkenyl-containing siloxane resin is a methylvinylpolysiloxane resin or a methylphenylvinylpolysiloxane resin, and
the alkenyl-containing straight chain diorganopolysiloxane is a straight chain dimethylpolysiloxane or a straight chain methylphenylpolysiloxane having vinyl groups at both terminals.

7. The liquid die bonding agent according to claim 3, wherein the organic solvent is a hydrocarbon solvent or a polyalkylene glycol alkyl ether ester solvent.

8. The liquid die bonding agent according to claim 3, further comprising (F) an organosilicon compound-based adhesion promoter, at 0.1 to 10 parts by mass per 100 parts by mass of component (A).

9. The liquid die bonding agent according to claim 4, wherein component (F) is an organosilane having a trialkoxysilyl group or dialkoxysilyl group, or is an organosiloxane oligomer having a trialkoxysilyl group or dialkoxysilyl group.

10. The liquid die bonding agent according to claim 5, wherein component (F) is an organosilane having a trialkoxysilyl group or dialkoxysilyl group, or is an organosiloxane oligomer having a trialkoxysilyl group or dialkoxysilyl group.
